(19) United States
(12) Patent Application Publication
(10) Pub. No.: US 2014/0003502 A1
(43) Pub. Date: Jan. 2, 2014

(54) Systems and Methods for Decoding Video Encoded Using Predictions that Reference Higher Rate Video Sequences

(71) Applicants: Kourosh Soroushian, San Diego, CA (US); Michael Papish, Randolph Center, VT (US)

(72) Inventors: Kourosh Soroushian, San Diego, CA (US); Michael Papish, Randolph Center, VT (US)

(73) Assignee: DIVX, LLC, Santa Clara, CA (US)

(21) Appl. No.: 13/539,365

(22) Filed: Jun. 30, 2012

(51) Int. Cl. H04N 7/32

(52) U.S. Cl. 375/240.12; 375/E07.243

(57) ABSTRACT

Systems and methods for decoding video encoded using predictions that include reference to other higher rate video sequences in accordance with embodiments of the invention are disclosed. One embodiment of the invention includes decoding at least a plurality of the frames in the first video sequence by: identifying information associated with the frame in the first video sequence that identifies a reference frame in the second video sequence; decoding the reference frame from the second video sequence identified by the information in the first video sequence; decoding the frame in the first video sequence using predictions based on the decoded reference frame; and skipping frames in the second video sequence that are not identified as reference frames by the information associated with the frames in the first video sequence.

### FIELD OF THE INVENTION

The present invention relates to video encoding and more specifically to compression of video sequences captured at high velocity and/or low frame rates.

### BACKGROUND

The term multiview video coding is used to describe processes that encode video captured by multiple cameras from different viewpoints. The basic approach of most multiview coding schemes is to exploit not only the redundancies that exist temporally between the frames within a given view, but also the similarities between frames of neighboring views. By doing so, a reduction in bit rate relative to independent coding of the views can be achieved without sacrificing the reconstructed video quality. The primary usage scenario for multiview video is to support 3D video applications, where 3D depth perception of a visual scene is provided by a 3D display system. There are many types of 3D display system including classic stereo systems that require special-purpose glasses to more sophisticated multiview auto-stereoscopic displays that do not utilize glasses. The stereo systems utilize two views, where a left-eye view is presented to the viewer's left eye, and a right-eye view is presented to the viewer's left eye.

Another application of multiview video is to enable free-viewpoint video. In this scenario, the viewpoint and view direction can be interactively changed. Each output view can either be one of the input views or a virtual view that was generated from a smaller set of multiview inputs and other data that assists in the view generation process. With such a system, viewers can freely navigate through the different viewpoints of the scene.

Multiview video contains a large amount of inter-view statistical dependencies, since all cameras capture the same scene from different viewpoints. Therefore, combined temporal and inter-view predictions can be utilized to more efficiently encode multiview video. Stated another way, a frame from a certain camera can be predicted not only from temporally related frames from video captured by the same camera, but also from frames of video captured at the same time by neighboring cameras. A sample prediction structure is shown in FIG. 1. Frames are not only predicted from temporal references, but also from inter-view references. The prediction is adaptive, so the best predictor among temporal and inter-view references can be selected on a block basis in terms of rate-distortion cost, or a combination of both temporal and inter-view reference can be used for different portions of the video frame.

Multiview Video Coding (MVC, ISO/IEC 14496-10:2008 Amendment 1) is an extension of the H.264/MPEG-4 Advanced Video Coding (AVC) standard that provides efficient coding of multiview video. The basic H.264/MPEG-4 AVC standard covers a Video Coding Layer (VCL) and a Network Abstraction Layer (NAL). While the VCL creates a coded representation of the source content, the NAL formats these data and provides header information in a way that enables simple and effective customization of the use of VCL data for a broad variety of systems

A coded H.264/MPEG-4 AVC video data stream is organized into NAL units, which are packets that each contain an integer number of bytes. A NAL unit starts with a one-byte indicator of the type of data in the NAL unit. The remaining bytes represent payload data. NAL units are classified into video coding layer (VCL) NAL units, which contain coded data for areas of the frame content (coded slices or slice data partitions), and non-VCL NAL units, which contain associated additional information. The set of consecutive NAL units associated with a single coded frame is referred to as an access unit. A set of consecutive access units with certain properties is referred to as an encoded video sequence. An encoded video sequence (together with the associated parameter sets) represents an independently decodable part of a video bitstream. An encoded video sequence always starts with an instantaneous decoding refresh (IDR) access unit, which signals that the IDR access unit and all access units that follow it in the bitstream can be decoded without decoding any of the frames that preceded it.

The VCL of H.264/MPEG-4 AVC follows the so-called block-based hybrid video coding approach. The way frames are partitioned into smaller coding units involves partitioning frames into slices, which are in turn subdivided into macroblocks. Each slice can be parsed independently of the other slices in the frame. Each frame is partitioned into macroblocks that each covers a rectangular area of 16×16 luma samples and, in the case of video in 4:2:0 chroma sampling format, 8×8 sample areas of each of the two chroma components. The samples of a macroblock are either spatially or temporally predicted, and the resulting prediction residual signal is represented using transform coding. Depending on the degree of freedom for generating the prediction signal H.264/MPEG-4 AVC supports three basic slice coding types that specify the types of coding supported for the macroblocks within the slice. An I slice uses intra-frame coding involving spatial prediction from neighboring regions within a frame. A P slice supports both intra-frame coding and inter-frame predictive coding using one signal for each prediction region (i.e. a P slice references one other frame of video). A B slice supports intra-frame coding, inter-frame predictive coding, and also inter-frame bi-predictive coding using two prediction signals that are combined with a weighted average to form the region prediction (i.e. a B slice references two other frames of video). In referencing different types of predictive coding, both inter-frame predictive coding and inter-frame bi-predictive coding can be considered to be forms of inter-frame prediction.

In H.264/MPEG-4 AVC, the coding and display order of frames is completely decoupled. Furthermore, any frame can be used as reference frame for motion-compensated prediction of subsequent frames, independent of its slice coding types. The behavior of the decoded picture buffer (DPB), which can hold up to 16 frames (depending on the supported conformance point and the decoded frame size), can be adaptively controlled by memory management control operation (MMCO) commands, and the reference frame lists that are used for coding of P or B slices can be arbitrarily constructed from the frames available in the DPB via reference picture list modification (RPLM) commands.

A key aspect of the MVC design extension to the H.264/MPEG-4 AVC standard is that it is mandatory for the compressed multiview stream to include a base view bitstream, which is coded independently from all other views. The video data associated with the base view is encapsulated in NAL units that have previously been defined for the 2D video, while the video associated with the additional views are encapsulated in an extension NAL unit type that is used for both scalable video coding (SVC) and multiview video. A flag is specified to distinguish whether the NAL unit is associated with an SVC or MVC bitstream.

Inter-view prediction is a key feature of the MVC design, and it is enabled in a way that makes use of the flexible reference frame management capabilities that are part of H.264/MPEG-4 AVC, by making the decoded frames from other views available in the reference frame lists from other views for use in inter-frame prediction. Specifically, the reference frame lists are maintained for each frame to be decoded in a given view. Each such list is initialized as usual for single-view video, which would include the temporal reference frames that may be used to predict the current frame. Additionally, inter-view reference frames are included in the list and are thereby also made available for prediction of the current frame.

In MVC, inter-view reference frames are contained within the same access unit as the current frame, where an access unit contains all the NAL units pertaining to a certain capture or display time instant (see for example the access units shown in FIG. 1). The MVC design does not allow the prediction of a frame in one view at a given time using a frame from another view at a different time. This would involve inter-view prediction across different access units.

With respect to the encoding of individual slices and macroblocks, the core macroblock-level and lower-level decoding modules of an MVC decoder are the same, regardless of whether a reference frame is a temporal reference or an inter-view reference. This distinction is managed at a higher level of the decoding process.

To achieve access to a particular frame in a given view, the decoder should first determine an appropriate access point. In H.264/MPEG-4 AVC, each IDR frame provides a clean random access point. In the context of MVC, an IDR frame in a given view prohibits the use of temporal prediction for any of the views on which a particular view depends at that particular instant of time; however, inter-view prediction may be used for encoding the non-base views of an IDR frame. This ability to use inter-view prediction for encoding an IDR frame reduces the bit rate needed to encode the non-base views, while still enabling random access at that temporal location in the bitstream. Additionally, MVC also introduces an additional frame type, referred to as an anchor frame for a view. Anchor frames are similar to IDR frames in that they do not use temporal prediction for the encoding of any view on which a given view depends, although they do allow inter-view prediction from other views within the same access unit (see for example FIG. 1). Moreover, it is prohibited for any frame that follows the anchor frame in both bitstream order and display order to use any frame that precedes the anchor frame in bitstream order as a reference for inter-frame prediction, and for any frame that precedes the anchor frame in decoding order to follow it in display order. This provides a clean random access point for access to a given view.

Many cameras, including cameras in mobile phone handsets, support geotagging of captured still and video images using geographic information captured using a Global Positioning System (GPS) receiver and other sensors such as accelerometers, and magnetometers. Geotagging is the process of adding geographical identification metadata to media. The geotag metadata usually includes latitude and longitude coordinates, though a geotag can also include altitude, bearing, distance, tilt, accuracy data, and place names. Geotags can be associated with a video sequence and/or with individual frames within the video sequence.

### SUMMARY OF THE INVENTION

Systems and methods in accordance with embodiments of the invention decode video sequences encoded using predictions that reference frames from at least one higher rate video sequence. In a number of embodiments, the encoded video sequence includes information that identifies the specific frames within the higher rate video sequence to enable decoding of the encoded sequence using the identified reference frames. One embodiment of the method of the invention includes decoding at least a plurality of the frames in the first video sequence by: identifying information associated with the frame in the first video sequence that identifies a reference frame in the second video sequence using the video decoding system; decoding the reference frame from the second video sequence identified by the information in the first video sequence using the video decoding system; decoding the frame in the first video sequence using predictions based on the decoded reference frame using the video decoding system; and skipping frames in the second video sequence that are not identified as reference frames by the information associated with the frames in the first video sequence.

In a further embodiment, both the first and second video sequences capture similar views of the scene in which the recording devices that captured the views of the scene were moving relative to the scene, and the second video sequence captures the scene at a higher rate, because the video recording device that captured it was travelling at a lower velocity relative to the scene than the video recording device that captured the first video sequence.

In another embodiment, the second video sequence captures a similar view of the scene at a higher rate than the first video sequence, because the second video sequence has a higher frame rate.

In a still further embodiment, a plurality of the frames of the first video sequence do not reference any frames in the second video sequence.

In still another embodiment, the first and second video sequences are encoded using different encoding parameters.

In a yet further embodiment, the first and second video sequences were captured using different video recording devices.

In yet another embodiment, the resolutions of the first and second video sequences are different, and decoding a reference frame from the second video sequence includes decoding a frame from the second video sequence, and resampling the decoded frame to the resolution of the encoded video sequence to generate the reference frame.

In a further embodiment again, the resampling process used by the video decoding system is predetermined.

In another embodiment again, the first video sequence is encoded as an elementary bitstream that includes metadata indicating a resampling process to apply to the frames of the second video sequence, and resampling the decoded frame to the resolution of the first video sequence to generate the reference frame further includes extracting the metadata indicating the resampling process to apply to the frames of the second video sequence from the elementary bitstream of the first video sequence using the video decoding system, and resampling the decoded frame to the resolution of the first video sequence using the indicated resampling process to generate the reference frame.

In a further embodiment again, the first video sequence is stored in a container file that includes metadata indicating a resampling process to apply to the frames of the second video sequence, resampling the decoded frame to the resolution of the first video sequence to generate the reference frame further includes extracting the metadata indicating the resampling process to apply to the frames of the second video sequence from the container file containing the first video sequence using the video decoding system, and resampling the decoded frame to the resolution of the first video sequence using the indicated resampling process to generate the reference frame.

In another embodiment again, metadata indicating the resampling process to apply to the frames of the second video sequence is stored in a database, and resampling the decoded frame to the resolution of the first video sequence to generate the reference frame further includes extracting the metadata indicating the resampling process to apply to the frames of the second video sequence from the database using the video decoding system, and resampling the decoded frame to the resolution of the first video sequence using the indicated resampling process to generate the reference frame.

In a further additional embodiment, the first video sequence is stored in a first container file, the second video sequence is stored in a second container file, and the method further includes obtaining video data including frames of the first video sequence from the first container file using the video decoding system, and obtaining video data including a frame of the second video sequence from the second container file in response to identifying information associated with a frame in the first video sequence that identifies the frame from the second sequence as a reference frame using the video decoding system.

Another additional embodiment further includes obtaining a top level index file that includes the location of the first and second container files using the video decoding system, and using the top level index file to obtain video data from the first and second container files using the video decoding system.

In a still yet further embodiment, the first and second video sequences are multiplexed into a single container file, and the method also includes obtaining video data including frames of the first video sequence from the container file using the video decoding system, and obtaining video data including a frame of the second video sequence from the container file in response to identifying information associated with a frame in the first video sequence that identifies the frame from the second sequence as a reference frame using the video decoding system.

In still yet another embodiment, configuring a first video decoder within the video decoding system to decode the second video sequence, and configuring a second video decoder within the video decoding system to decode frames from the first video sequence using at least one frame from the second video sequence decoded by the first video decoder.

In a still further embodiment again, a geotag is associated with at least one of the frames of the first video sequence, and the method further includes determining a velocity associated with the frame in the first sequence that is being decoded by the video decoding system using at least the geotag, and applying a filter to the reference frame from the second video sequence identified by the information associated with the first video sequence using the video decoding system, where the filter is selected based upon the velocity associated with the frame in the first sequence.

Another further embodiment includes a processor, and memory containing a playback application. In addition, the playback application configures the processor to: store at least a portion of a first video sequence that captures a view of a scene and is encoded using predictions that include references to a second video sequence that captures a similar view of the scene at a higher rate in memory; and store at least a portion of the second video sequence in memory. Furthermore, the playback application decodes at least a plurality of the frames in the first video sequence by configuring the processor to: identify information associated with the frame in the first video sequence that identifies a reference frame in the second video sequence; decode the reference frame from the second video sequence; decode the frame in the first video sequence using predictions based on the decoded reference frame; and skip frames in the second video sequence that are not identified as reference frames by the information associated with the frames in the first video sequence.

In still another further embodiment, both the first and second video sequences capture similar views of the scene in which the recording devices that captured the views of the scene were moving relative to the scene, and the second video sequence captures the scene at a higher rate, because the video recording device that captured it was travelling at a lower velocity relative to the scene than the video recording device that captured the first video sequence.

In yet another further embodiment, the second video sequence captures a similar view of the scene at a higher rate than the first video sequence, because the second video sequence has a higher frame rate.

Another further embodiment again includes a machine readable medium containing processor instructions, where execution of the instructions by a processor causes the processor to perform a process that includes storing at least a portion of a first video sequence that captures a view of a scene and is encoded using predictions that include references to a second video sequence that captures a similar view of the scene at a higher rate in memory, storing at least a portion of the second video sequence in memory, and decoding at least a plurality of the frames in the first video sequence by: identifying information associated with the frame in the first video sequence that identifies a reference frame in the second video sequence; decoding the reference frame from the second video sequence; decoding the frame in the first video sequence using predictions based on the decoded reference frame; and skipping frames in the second video sequence that are not identified as reference frames by the information associated with the frames in the first video sequence.

### BRIEF DESCRIPTION OF THE DRAWINGS

FIG. 1 conceptually illustrates video encoded in accordance with the MVC extension of the H.264/MPEG-4 AVC video standard.

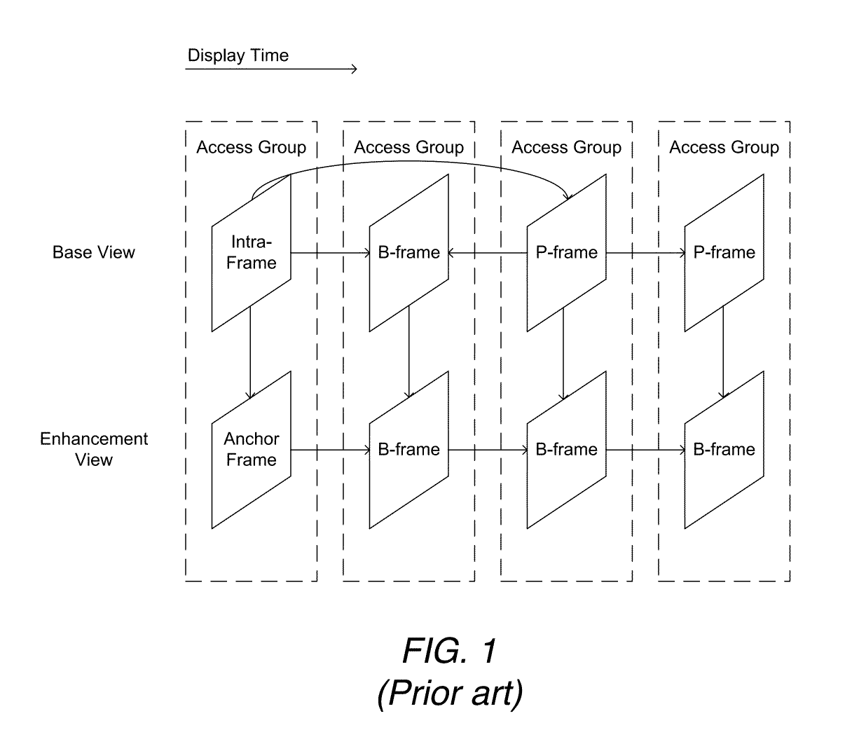

FIG. 2 conceptually illustrates a video sharing system in accordance with an embodiment of the invention.

FIG. 2A conceptually illustrates encoding of a video sequence using reference frames from a plurality of reference segments taken from at least one different video sequence in accordance with embodiments of the invention.

FIG. 3 is a flow chart illustrating a process encoding captured video sequences in accordance using predictions based upon video segments contained within a geotagged video database in accordance with an embodiment of the invention.

FIG. 4 is a flowchart illustrating a process for identifying a video segment within a geotagged video database that is the closest match to specific video segment in accordance with an embodiment of the invention.

FIG. 5 is a flow chart illustrating a process for identifying video segments within a geotagged video database that are likely to contain similar views of a scene recorded in a specific video segment using geotags in accordance with an embodiment of the invention.

FIG. 6 is a flow chart illustrating a process for identifying a video segment that most closely matches a specific video segment in accordance with an embodiment of the invention.

FIG. 7 conceptually illustrates encoding of a video segment using prediction with respect to intra-frames in a captured video segment and storage of the encoded video segment in a container file in accordance with embodiments of the invention.

FIG. 8 conceptually illustrates encoding of a video segment using inter-frame prediction and predictions based on reference frames from another video segment and storage of the encoded video segment in a container file containing reference frames in accordance with embodiments of the invention.

FIG. 9 conceptually illustrates the encoding of a video segment using predictions based on reference frames from another video segment that are selected based upon the relative velocity of the recording devices that captured the video segments in accordance with embodiments of the invention.

FIG. 10 is a timing diagram showing communication between a playback device and a video sharing server system during the downloading of video segments and reference frames from the video sharing server system by the playback device, and during the decoding and playback of the video segments by the playback device in accordance with an embodiment of the invention.

FIG. 11 is a timing diagram showing communication between a playback device and a video sharing server system during the transcoding of at least one video segment into a conventional video bitstream by the video sharing server system for downloading by playback device, and during the decoding and playback of the transcoded bitstream by the playback device in accordance with an embodiment of the invention.

FIG. 12 conceptually illustrates a playback device in accordance with an embodiment of the system.

FIG. 13 conceptually illustrates a video sharing server system in accordance with embodiments of the invention.

### DETAILED DESCRIPTION

Turning now to the drawings, systems and methods for decoding video encoded using predictions that include reference to other higher rate video sequences in accordance with embodiments of the invention are illustrated. As the amount of video stored in the video sharing system increases, the likelihood that new video added to the video sharing system contains a view of a scene that is similar to a view of the scene captured in another video recording also increases. In several embodiments, video is captured by “always on” video recording devices. Due to the daily routines of the users of these video recording devices and the similarity of certain portions of the daily routines of different users, the likelihood of similarity in the scenes captured by such video recording devices is also high. When the captured video sequences are geotagged, the geotag(s) of a newly captured video sequence can be utilized to identify segments of video within a geotagged video database (i.e. a database of geotagged video) that contain views of the scenes in the newly captured video sequence. Accordingly, video sharing systems in accordance with embodiments of the invention can compress the overall size of a geotagged video database by encoding video sequences using prediction based on segments of video stored within the geotagged video database. The predictions are performed in a manner similar to any inter-frame predictive or bi-predictive inter-frame coding, however, the constraints imposed in multiview encoding associated with the assumption that the views are captured at the same time are relaxed to account for the video segments being captured by unsynchronized cameras and/or at different times. In discussing systems and methods in accordance with embodiments of the invention, predictions that include references to a reference frame can be considered as including (but not being limited to) inter-frame predictions and bi-predictive inter-frame coding using the reference frame and another frame (typically in the sequence being encoded). In many embodiments, a captured video sequence may include two or more video sequences that are synchronized (e.g. video captured in stereo 3D). Therefore, some of the video in the geotagged video database may be synchronized with one or more video sequences in the database. Relaxing the constraints imposed by multiview encoding, however, enables further compression by exploiting redundancy with video sequences that are not synchronized with one or more captured video sequences.

In many embodiments, a captured video sequence is divided into segments and the segments are encoded using prediction based upon segments of video contained within the geotagged video database that contains similar views of the scenes recorded in one or more segments of the captured video sequence. In a number of embodiments, the geotagged video database includes a large number of different video sequences and a set of geotagged video segments from the different video sequences that contain similar views of a scene can be initially identified using a geotag associated with the segment of the captured video. The extent to which geotags indicate a match depends on the information contained within the geotag. Latitude and longitude information within a geotag can indicate that a video segment is relevant (i.e. that a video segment was captured close by and/or is likely to record a similar view of a scene). Information concerning altitude, bearing and tilt can increase the confidence that a video segment contains a similar view of a scene. Information concerning the time of capture can also indicate the extent to which the scene itself is likely to have changed.

Based on an initial set of video segments identified using geotags, the video segment that is the best match to the segment of the captured video sequence can be identified based upon the content of the segments. In several embodiments, feature matching is utilized to determine the similarity of the content of video segments. In certain embodiments, a comparison of the photometric similarity of the video segments is performed when determining the video segment that is the best match. The captured video segment can then be encoded using prediction based on the segment of video from the geotagged video database that is the closest match.

In a number of embodiments, the video segments from a captured video sequence that are encoded using prediction based upon references frames from other video segments are single intra-frames. In this way, compression is achieved by simply matching single frames between the captured video sequence and frames within the geotagged video database. In other embodiments, the reference video segments include multiple frames and are encoded using prediction based upon closely matching segments of video from the geotagged video database. When a video sequence is captured at a high velocity (i.e. the video recording device is in motion) or low frame rate, significant compression gains can be obtained by using prediction based on reference frames from video segments captured at lower velocities and/or higher frame rates to encode segments of the captured video sequence. At high velocity or low frame rate, prediction between frames in the captured video sequence may be inaccurate leading to inefficiency in the video encoding process. Accordingly, the velocity at which a scene is captured and the frame rate at which the scene is captured can have similar impacts on encoding efficiency and can be collectively referred to as the rate of the video. A high rate corresponds to a low velocity and/or high frame rate. A low rate corresponds to a high velocity and/or low frame rate. Where a geotagged video database contains a similar video sequence captured at a higher rate, predictions based upon frames from a video segment captured at a higher rate can be used to improve the efficiency of the encoding of the captured video sequence by providing better predictions than are possible using inter-frame prediction alone. In several embodiments, a geotag including velocity information associated with a frame that is being encoded can be utilized to apply a filter such as (but not limited to) a filter that applies blur simulating motion blur to increase the similarity of a frame in a reference segment. In this way, additional compression gains can be obtained through application of the filter. In several embodiments, the blurring may take place individually on each frame, or alternatively by applying transformations on a combination of two or more frames. In a number of embodiments, a similar effect can be achieved using bi-predictive filtering utilizing the preceding frame in the captured video segment and the reference frame selected from the reference video segment. In other embodiments, any of a variety of filters can be applied to the references of a reference segment to increase similarity to a frame of a captured video segment.

When video is requested from a video sharing website in accordance with an embodiment of the invention, a video sequence that is encoded using predictions that include references to other video segments can be delivered to the playback device including a video decoding system along with the referenced video segments. Alternatively, the video sharing system can transcode the video sequence into a conventional video bitstream (i.e. a bitstream that does not include predictions based on reference frames from other video segments) to reduce the bandwidth utilized when transmitting the requested video sequence.

Due to the ability to perform encoding using predictions that reference frames that themselves rely upon predictions from reference frames in other video segments, the amount of data provided to a playback device or the complexity of the transcoding process used when providing data to a playback device is directly related to the number of video segments on which the predictions used in the encoding of the requested video sequence depend. In several embodiments, the video sharing system limits the number of dependencies allowed when encoding a video sequence. In a number of embodiments, the video sharing system transcodes video segments stored in the geotagged video database to conventional video bitstreams in order to reduce the number of dependencies when encoding a video sequence. In many embodiments, the transcoding of a video segment into a conventional video bitstream prompts the reencoding of other video segments within the geotagged video database.

Systems and methods for sharing geotagged video and for encoding video sequences using predictions that reference frames in video segments stored within a geotagged video database to reduce the overall size of the geotagged video database in accordance with embodiments of the invention are discussed further below.

### Video Sharing Systems

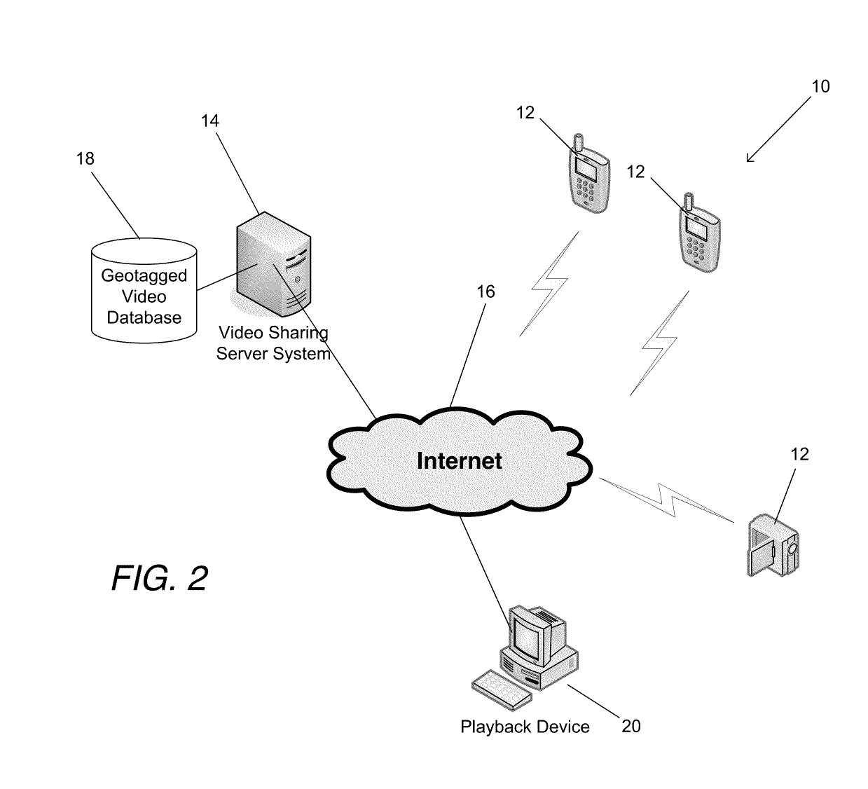

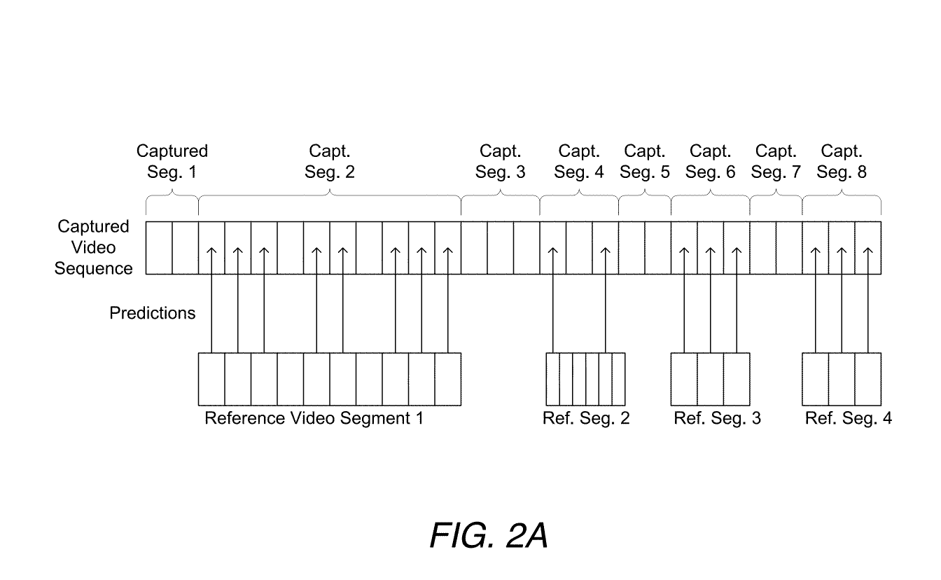

A video sharing system in accordance with an embodiment of the invention is illustrated in FIG. 2. In the illustrated embodiment, a variety of video recording devices 12 capture and geotag video sequences, which are then streamed and/or uploaded to a video sharing server system 14 via the Internet 16. In many embodiments, the video recording devices 12 are “always on” video recording devices that are worn by users and continuously capture video from the viewpoint of the user. The video recording devices can also be conventional video recording devices that either directly stream video to the video sharing server system 14 or capture video that is uploaded to the video sharing server system 14.

The video sharing server system 14 stores the video captured by the video recording devices 12 in a geotagged video database 18. As part of the process of storing the video captured by the video recording devices 12, the video sharing server system 14 can attempt to reduce the size of the captured video sequences by reencoding frames of the captured video sequences using predictions based on video segments contained within the geotagged video database 18. As the amount of video stored within the geotagged video database increases, the likelihood that newly captured video sequences contain segments of video that are similar to segments of video contained within the geotagged video database also increases. The likelihood that a geotagged video database contains similar video segments to a captured video sequence increases considerably where an “always on” video recording device captures the video sequence. Due to the fact that “always on” video recording devices typically capture video from the viewpoint of a user, similarity within a user's daily routine and between users' daily routines results in “always on” video recording devices capturing a significant amount of video of the same subject matter from similar viewpoints in an unsynchronized manner and at different times (although different users may capture a similar view in an asynchronous manner at the same time).

A playback device 20 that includes a video decoding system can request video stored in the geotagged video database 18 from the video sharing server system 14. In several embodiments, the video sharing server system 14 provides the playback device 20 with the requested video sequence and the relevant reference frames used in the decoding of the requested video sequence from the geotagged video database 18. In several embodiments, the video server system provides a top level index file and the playback device can use the index file to request the video sequence and the reference files using Hypertext Transfer Protocol (HTTP) or another appropriate stateless (or stateful) data transfer protocol. In many embodiments, the video sharing server system 14 uses the references to relevant reference frames in the requested video sequence to transcode the requested video sequence as a conventional video bitstream (i.e. a sequence of video frames that does not include references to frames in other video segments). The transcoded bitstream is then provided to a playback device. In this way, the bandwidth utilized in providing the requested bitstream is reduced relative to the bandwidth utilized in sending reference frames from the other segments that are the basis of predictions. In a number of embodiments, the video sharing server system multiplexes the encoded video sequence and the relevant frames from the reference segments into a container file that is accessible to playback devices. In other embodiments, any of a variety of techniques can be utilized to provide the encoded video sequence and the reference segments referenced in the encoding the encoded video sequence to a playback device.

In many embodiments, the video sharing server system 14 attempts to compress a captured video sequence by identifying a segment of video in the geotagged video database 18 that can be used in the encoding of a segment of the captured video sequence. In several embodiments, the video sharing server system 14 attempts to compress a captured video sequence by encoding intra-frames of the captured video sequence using predictions based on frames selected from the geotagged video database 18. In this way, the video sharing system obtains the benefits in compression associated with reducing the size of the intra-frames in the captured video sequence and at the same time simplifying the process of locating matching video segments. In other embodiments, the video segments utilized during encoding contain multiple frames.

In a number of embodiments, the video sharing server system 14 can identify potentially similar segments of video and/or frames of video in the geotagged video database 18 using geotags associated with a captured sequence of video by a video recording device 12. From a set of potentially similar frames of video and/or video segments, the video sharing server system 14 can identify the frame of video and/or video segment that is the best match when encoding a captured video sequence based upon factors including (but not limited to) scene similarity and photometric similarity.

The use of a number of reference video segments in the encoding of a captured video sequence in accordance with embodiments of the invention is conceptually illustrated in FIG. 2A. In the illustration, the frames of a captured video sequence are shown. Some of the frames of the captured video sequence can be encoded using predictions from the frames of reference video segments. As can readily be appreciated, not all segments from a captured video sequence will necessarily include content that corresponds to a video segment stored in a geotagged video database. Accordingly, predictions based upon video segments from the geotagged video database are not used in the encoding of Captured Segments 1, 3, 5, and 7. Similar video segments were able to be located in a geotagged video database to enable the encoding of Captured Segments 2, 4, 6, and 8 with Reference Segments 1, 2, 3, and 4 respectively. Different cameras may capture the reference segments, at different times, and from different perspectives. Typically, the reference segments are extracted from various video sequences stored in the geotagged video database. The extraction process can occur at the point of ingest and/or in response to a segment in a video sequence being identified as being a relevant reference segment for use in the encoding of a captured video segment. As can readily be appreciated, not all frames in a video segment are encoded using predictions from frames in a reference segment (see for example Captured Segment 2 and Reference Segment 1). In addition, the captured segment can be encoded using reference frames from a reference segment captured at different frame rates (see for example Captured Segment 4 and Reference Segment 2) or at different resolutions. Processes to identify similar segments in a geotagged video database that can be utilized in the encoding of a captured video sequence and processes for encoding segments within the captured video sequence using the reference segments in accordance with embodiments of the invention are discussed further below.

Although a specific video sharing system is illustrated in FIG. 2, any of a variety of system architectures can be utilized to implement video sharing systems in accordance with embodiments of the invention including systems in which the video sharing server system includes a plurality of servers performing different functions and/or in different geographic locations. In addition, the geotagged video database can include metadata concerning video sequences stored elsewhere on video distribution servers such as (but not limited to) the servers of a content distribution network. Accordingly, video sequences can be understood as being contained within a geotagged video database in circumstances where the video sequences are not stored within the database, but metadata concerning the video sequences (including geotags and the location of the video sequence) is stored within the geotagged video database. Processes for encoding video sequences for storage in a geotagged video database in accordance with embodiments of the invention are discussed further below.

### Encoding Captured Video Sequences

A large database of geotagged video sequences is likely to contain video segments that are similar to video segments within a video sequence captured by a video recording device. One or more geotags on a captured video sequence can be utilized to identify video segments within a geotagged video database that can be used as the source of reference frames in the encoding of a captured video sequence.

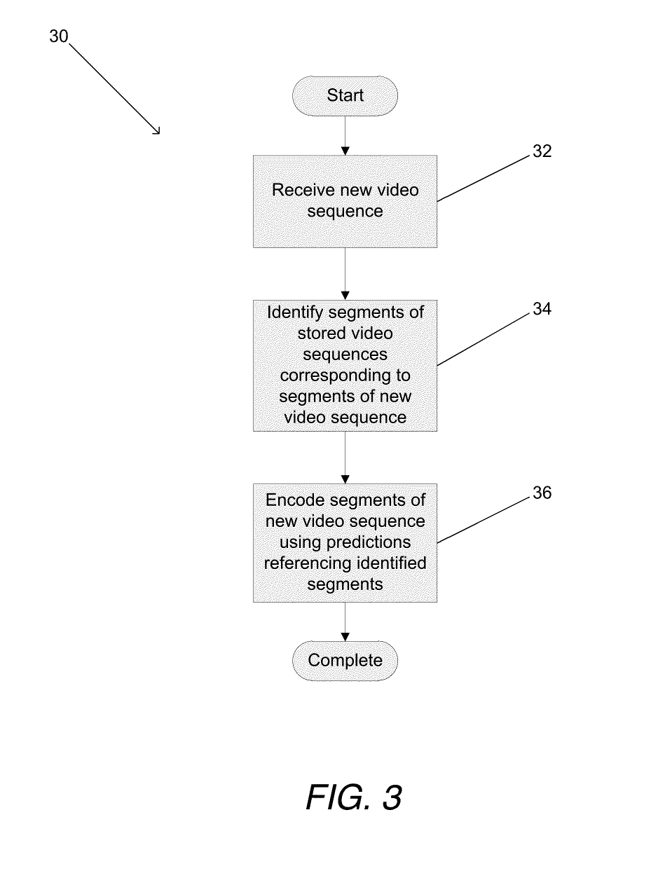

A process for encoding a captured video sequence for storage in a geotagged video database in accordance with an embodiment of the invention is illustrated in FIG. 3. The process 30 includes receiving (32) the captured video sequence directly from the video recording device or indirectly via the uploading of the captured video sequence. In many embodiments, one or more video segments are identified in a captured video sequence. A variety of criteria can be utilized in determining the video segments including discrete time intervals, scene changes, and/or the location of intra-frames within the captured video sequence. Segments of video stored within the geotagged video database that contain similar views as segments of the captured video sequence are then identified (34) using geotags and by comparing the content of the video segments. The identified video segments from the geotagged video database can then be used as reference to encode (36) segments of the captured video sequence using predictions to increase compression.

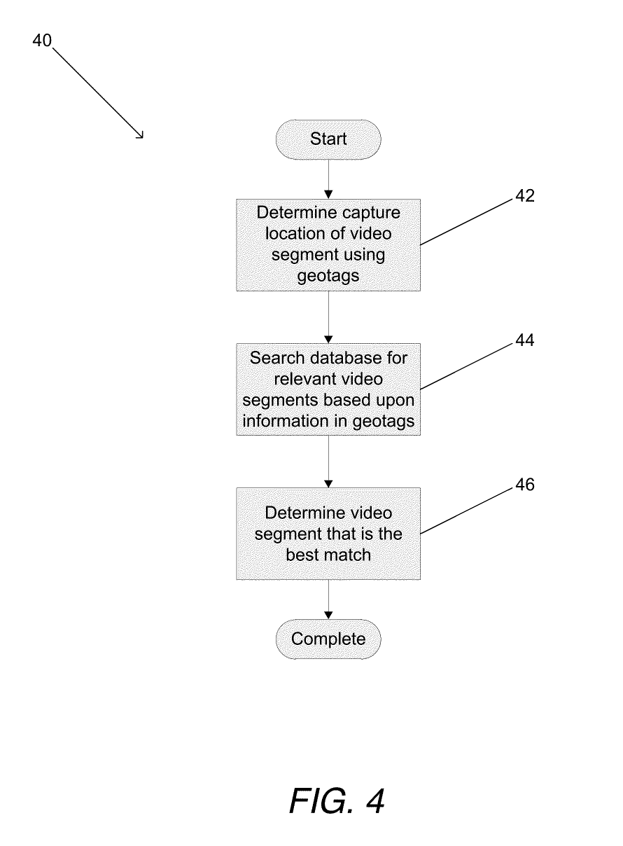

A process for locating a segment of video containing a similar view to a segment of video from a captured video sequence is illustrated in FIG. 4. The process 40 includes determining the capture location of a segment from the captured video sequence using one or more geotags associated with the captured video sequence. The capture location can be considered the geographic location from which a specific video sequence, video segment, and/or video frame (depending on the granularity of a geotag) was captured. In many embodiments, the captured video sequence includes one or more geotags associated with the entire video sequence. In several embodiments, individual frames of the captured video sequence include one or more geotags.

The geotag(s) associated with a video segment of the captured video are used to search (44) the geotagged video database for video segments that are likely to include similar views of the scene. The extent to which similar views of a scene can be identified based upon geotags is largely dependent upon the information contained within the geotags. The geotag metadata usually includes latitude and longitude coordinates. These coordinates can be utilized to identify video segments that were captured from geographically proximate locations. Additional information in a geotag such as (but not limited to) the capture altitude, bearing, and tilt can provide information concerning the specific view of the scene captured by the video segment. Also, accuracy data, time of day, date and place names can be utilized to determine the similarity of the viewpoints from which the video segments were captured.

The geotags enable the identification of a set of video segments that are likely to contain similar views of the scene recorded in a captured video segment. The video segment that provides the best match as a reference segment for the purposes of encoding the captured video segment can be determined (46) by performing view matching. View matching involves comparing the content of one or more frames of the video segments from the geotagged video database with the video segment from the captured video sequence. The video segment that contains the content that is the most similar can be used in the encoding of the captured video segment. The criteria that can be used in the determination of the similarity of the content of frames and the video segment most suited for use in the encoding of another video segment are discussed further below.

Although specific processes are illustrated in FIGS. 3 and 4 for encoding captured video sequences using predictions based upon reference video segments from a geotagged video database, any of a variety of processes can be utilized to identify video segments containing similar views of scenes recorded in a captured video sequence and for encoding the captured video sequence using predictions from frames in reference segments to increase compression in accordance with embodiments of the invention. Processes for identifying video segments that are likely to contain similar views based upon geotags and for determining the similarity between video segments based upon the content of the video segments in accordance with embodiments of the invention are discussed further below.

### Locating Video Segments Containing Similar Views of a Scene

Video segments contained within a geotagged video database contain views of a variety of scenes. Processes for encoding a captured video sequence in accordance with embodiments of the invention, can involve identifying video segments from one or more video sequences in the geotagged video database that can be utilized as reference segments during encoding. Geotags can be utilized to perform a coarse search of the geotagged video database to locate video segments that are likely to contain similar views of a scene recorded in a segment of the captured video sequence. The video segments that contain similar views, however, are likely to exhibit variation in appearance and viewing parameters as they may be acquired by an assortment of cameras at different times of day and in various ambient lighting conditions. Typical multiview algorithms consider images with far less appearance variation, where computing correspondence is significantly easier, and have typically operated on somewhat regular distributions of viewpoints (e.g. photographs regularly spaced around an object, or video streams with spatiotemporal coherence). As the amount of video stored in the geotagged video database increases, there should be a large subset of video segments of any particular scene that a video segment with matching lighting, weather, and exposure conditions, as well as sufficiently similar resolution can be identified. By automatically identifying video segments in the database that are compatible with video segments from the captured video sequence, muliview video encoding techniques can be used to encode the frames of video of the new sequence using segments of video from the database as the baseline view.

### Locating Video Segments Using Geotags

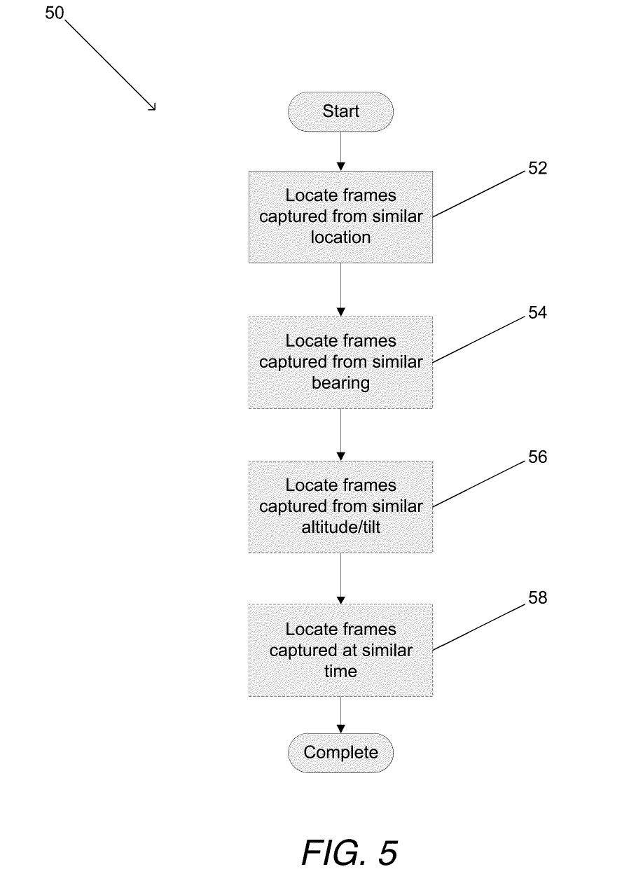

A process for using geotags to locate video segments that are likely to be similar to a captured video segment in accordance with an embodiment of the invention is illustrated in FIG. 5. The process 50 includes locating (52) video segments including at least one frame of video captured from a similar geographic location as a frame of video in the captured video segment. In many embodiments, the measure of whether a video segment is captured from a similar geographic location is adaptive and the process returns a predetermined number of video segments closest to a geographic location. In other embodiments, alternative adaptive techniques are utilized and/or predetermined distance thresholds are imposed when determining the similarity of the geographic location of two video segments.

In situations where a geotag only includes the geographic location of a video segment, a greater burden is placed on the comparison of the content of the video segments in order to determine the video segment that is the best match for encoding the captured video segment. If additional information concerning the direction from which a video segment was captured is available, the additional information can be used to obtain a better initial set of video segments (i.e. a set that is much more likely to include views of the scene recorded in the captured video segment). In this way, less processing is involved in determining the sequence that is the best match as fewer sequences are considered. In the illustrated embodiment, geotags are used to identify video segments that more closely correspond to a captured video segment by comparing the bearing (54), the altitude and/or tilt (56), and time (58) at which frames in the video segments were captured. Ideally, the frames that include the closest matches in location, bearing, altitude/tilt, time of day, and date are likely to have the closest similarity to the captured video segment. The relative weighting of each of these parameters will typically depend upon the requirements of a specific application. For example, the importance of the date can drop off considerably with increasing distance in time. Alternatively, the time of day and/or time of year can be considered in combination to determine the similarity of ambient lighting conditions. In several embodiments, the geotags can also include temperature and other information including (but not limited to) light levels and humidity. Accordingly, the specific factors that are considered when identifying video segments from a geotagged video database that are likely to contain similar views of a scene recorded in a captured video sequence are typically only limited by the requirements of a specific application. Once video segments within a geotagged video database that are likely to contain a similar view of a scene recorded in a captured video segment are identified using geotags, the video segment in the geotagged video database that is the closest match to the captured video segment can be identified by a comparison of the content of the video segments.

### Determining Similarity Based on Content of Video Segments

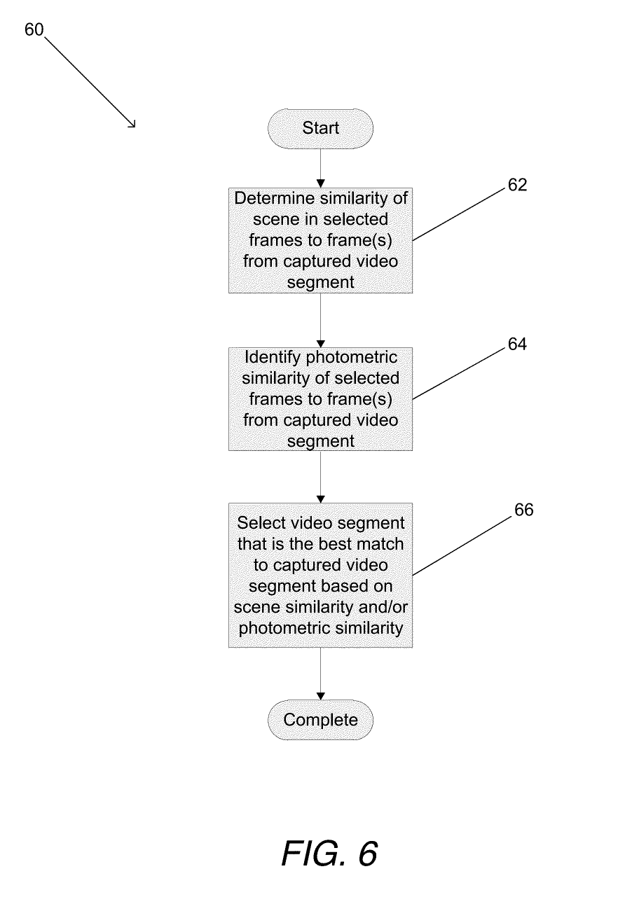

Matching processes in accordance with embodiments of the invention attempt to locate frames of video that are good matches to frames of video in a captured video segment based upon factors including (but not limited to) scene content, appearance, and scale. A process for identifying a video segment from a set of video segments (identified using geotags) that is the best match to a captured video segment in accordance with an embodiment of the invention illustrated in FIG. 6. The process 60 includes determining (62) the similarity of the scene in one or more frames of a video segment from the geotagged video database to one or more frames in the captured video segment. In addition, the process involves determining (64) the photometric similarity of one or more frames of a video segment from the geotagged video database to one or more frames in the captured video segment. Based upon the similarity of the scene and the photometric similarity of the video segments, a video segment from the geotagged video database can be selected (66) as the best match. As noted above, the captured video segment can then be encoded using predictions based upon the selected video segment.

A variety of processes can be utilized for determining (62) the similarity of the scene in different frames of video in accordance with embodiments of the invention. The term structure from motion (SfM) in image processing describes the problem of attempting to recover the 3D geometry of a scene using images obtained from an uncalibrated camera. A variety of techniques have been developed for determining the number of shared feature or correspondence points between images for use in SfM applications. In a number of embodiments, similar techniques are utilized to determine shared feature points between a frame of video from the geotagged video database and a frame of video from a captured video segment. The frames with the most shared feature points tend to be nearly collocated. In a number of embodiments, the shared feature points are determined using a scale-invariant feature transform (SIFT) feature detector that is capable of determining matches between images of substantially different resolutions. In other embodiments, any of a variety of processes can be utilized to determine the similarity of the scenes recorded in a frame of video from the geotagged video database and a frame of video from a captured video segment.

In addition to determining consistency of the scene using feature points, the photometric consistency of the frames can be determined (64) using a variety of metrics. In several embodiments, mean-removed normalized cross correlation is utilized to identify photometric consistency between matching frames. In other embodiments, any of a variety of other robust matching metrics can be utilized including (but not limited to) metrics that have been developed to enable matching with variable lighting, variable focus, non-Lambertian reflectance, and large appearance changes.

In a number of embodiments, processes that look at a variety of characteristics of one or more frames when comparing video segments can be utilized including processes that compare mean, variance, and/or skew of the RGB or YUV components and/or in a manner similar to that outlined in U.S. Pat. No. 6,246,803, entitled “Real-Time Feature-Based Video Stream Validation and Distortion Analysis System Using Color Moments”, to John Gauch (the disclosure of which is incorporated by reference herein in its entirety).

In many embodiments, the geotagged video database includes video segments captured by the same recording device that captured the video sequence that is being encoded. Video sharing systems that receive video captured by always on video recording devices, in particular, are likely to contain large amounts of video data captured by a single recording device. The geotagged video database can contain information concerning the recording device that captured individual video segments including but not limited to information that uniquely identifies recording devices and product information that indicates a type or product category of a recording device, which may be as specific as the lens and sensor configurations. In several embodiments, the process of locating a video segment containing a similar view of a scene to a captured video segment can be limited (initially) to video segments captured using the same recording device. In a number of embodiments, the cost function utilized to determine the video segment that is the best match to the captured video segment considers whether a video segment was captured using the same recording device and/or the same type of recording device.

As can be readily appreciated, the efficiency of the encoding process is largely dependent on the similarity (i.e. redundancy) between the video segments. In several embodiments, a cost function is utilized to determine the video segment that is the closest match based upon the similarity of the scene and the photometric consistency between the frames of the video segments. In many embodiments, the cost function more heavily weights the similarity between the intra-frame(s) in the video segments in recognition that the greatest compression can be achieved by replacing intra-frame(s) with frames encoded using predictions that reference a similar frame from a reference segment. As is discussed further below, several encoding processes in accordance with embodiments of the invention only use predictions from frames within reference segments in the encoding of intra-frames. In which case, the search for matching video segments is reduced to a search for frames that match the intra-frames of the captured video segments. Processes for encoding captured video segments using prediction based upon reference video segments contained within a geotagged video database in accordance with embodiments of the invention are discussed further below.

Encoding Captured Video Segments Using Predictions from Reference Segments

The simplest and largest improvement in the encoding of a captured video sequence is obtained when intra-frames are encoded using predictions from frames in reference segments. Additional encoding efficiency gains can be obtained by using predictions that reference frames in reference segments in the encoding of additional frames in a captured video sequence. The number of frames of a captured video sequence that can be encoded using predictions to a reference segment can depend upon the similarity of the frames of a segment of the captured video sequence to the reference segment. Where there is a low likelihood that an entire video segment that is similar can be located within a geotagged video database, then a video sharing system in accordance with embodiments of the invention can simply search for intra-frames or anchor frames in the geotagged video database that correspond to the intra-frames within a captured video segment (or simply encode the video segment using intra-frame and inter-frame predictions). Where there is a high likelihood that a similar video segment can be located within a geotagged video database, then the captured video segment can be encoded in a similar manner to an enhancement view in multiview encoding.

Encoding Intra-Frames Using Reference Frames from Other Segments

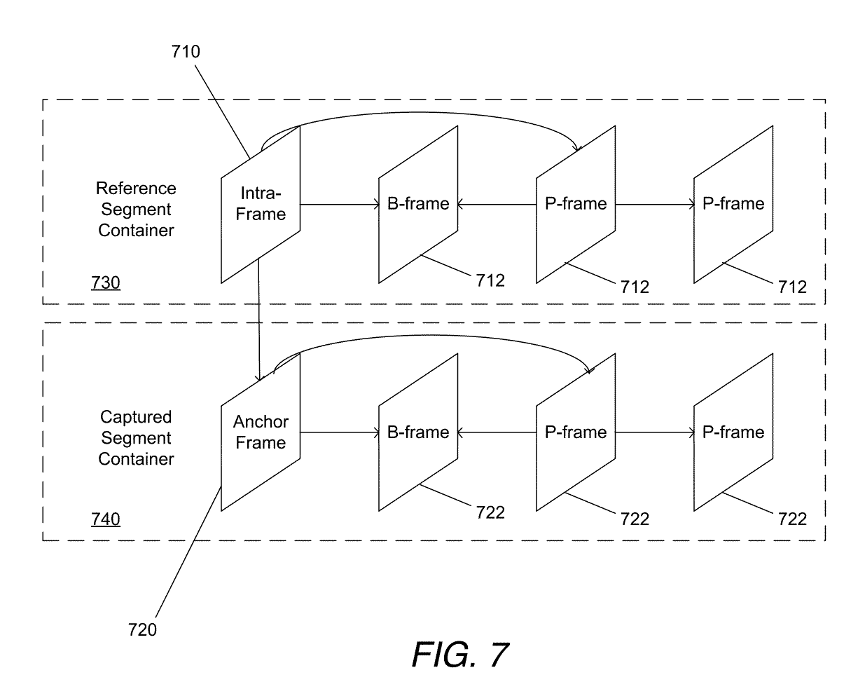

In a number of embodiments, the video segments from a captured video sequence that are encoded using predictions to reference segments retrieved from a geotagged video database are single intra-frames. In this way, compression is achieved by simply matching single frames between the captured video sequence and frames within the geotagged video database. The encoding of intra-frames in a captured video segment using predictions to reference frames from a video segment from a different video sequence in accordance with embodiments of the invention is conceptually illustrated in FIG. 7. A video segment from a geotagged video database constitutes a reference segment. In the illustrated embodiment, the reference segment includes an intra-frame 710 and a plurality of additional frames (712) encoded using inter-frame prediction. A captured video segment is represented by a second sequence of frames. The captured video segment is encoded so that the initial frame is encoded using predictions that include references to a frame in the reference segment. The additional frames (722) of the captured video segment are encoded using inter-frame prediction, but not utilizing predictions that reference frames of the reference segment. By only using predictions to the reference segment in the encoding of the initial (intra-frame) in the captured video segment, the relative frame rate of the reference segment and the captured segment is largely irrelevant. In addition, the amount of additional overhead in streaming the captured video segment and the reference frames from the reference segment is approximately equivalent to the size of the frames in the captured video segment that reference the reference segment (i.e. the remaining frames from the reference segment need not be streamed in order to decode the captured video segment). In many instances, photometric differences between an intra-frame of a captured video segment and an intra-frame of a reference segment can decrease encoding efficiency. Accordingly, filters can be applied to the reference segment to compensate for variations in photometric differences including (but not limited to) variations in the focal distance used by the video recording devices to capture the video segments. Application of filters in this way can increase the compression achieved through use of predictions that include references to frames in reference segments. In a similar way, resampling the reference segment to the same resolution as the captured video segment prior to generating predictions can accommodate resolution differences. As is discussed below, the decoding of captured video segments encoded using reference segments of a different resolution also involves resampling the reference frames prior to decoding the encoded video segment. Ideally, the resampling processes used in the encoding and the decoding are the same or vary within a margin that is appropriate to the requirements of a specific application.

Although specific processes are discussed above involving the encoding of intra-frames of a captured video segment using predictions that include references to frames in a reference segment, predictions can be made based upon reference frames that themselves encoded using predictions that reference frames in yet another reference segment. Accordingly, the encoding of a captured video segment in accordance with embodiments of the invention can depend upon multiple video segments within a geotagged video database. In addition, systems and methods in accordance with embodiments of the invention are not limited to simply using predictions based on reference frames in video segments from different video sequences in the encoding of intra-frames of a captured video segment. Systems and methods for encoding captured video segments using predictions that include references to multiple frames in a reference segment in accordance with embodiments of the invention are discussed further below.

### Compressing Video Segments Using Multiview Encoding

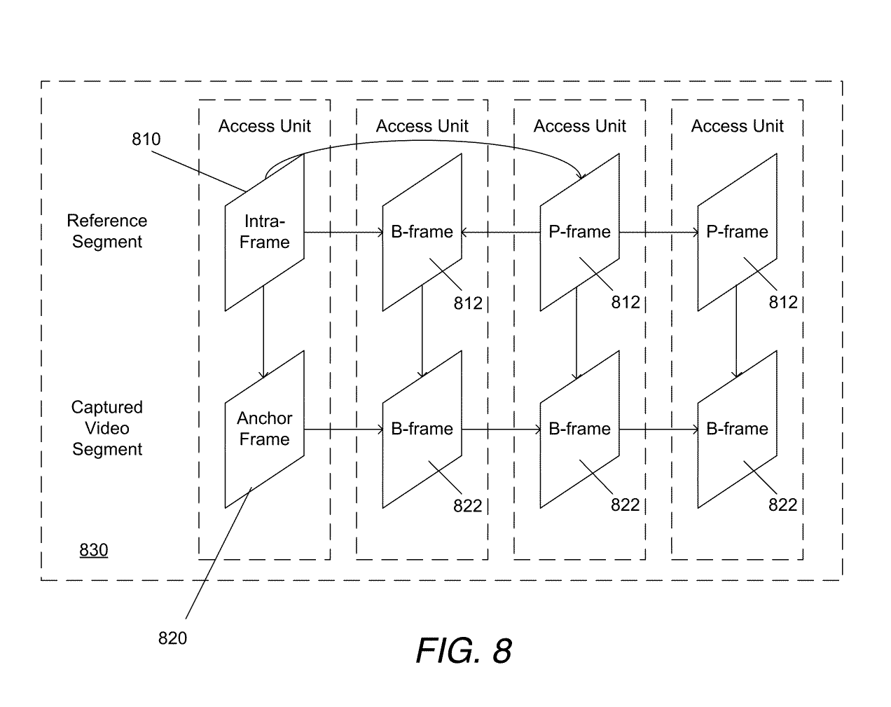

In many embodiments, captured video segments are encoded using predictions that reference multiple frames in reference segments from a geotagged video database. The encoding of a captured video segment using predictions that include references to multiple frames in a reference segment from a different video sequence in accordance with embodiments of the invention is conceptually illustrated in FIG. 8. A video segment from a geotagged video database constitutes a reference segment. In the illustrated embodiment, the reference segment includes an intra-frame 810 and a plurality of additional frames (812) encoded using intra-frame, and/or inter-frame prediction. A captured video segment is represented by a second sequence of frames. The initial (intra-frame) frame 820 and the additional frames (822) of the captured video segment are encoded using predictions that include predictions to the frames of the reference segment. In the illustrated embodiment, the captured video segment is encoded using predictions that include references to frames in the reference segment. In many embodiments, a captured video segment can be encoded using reference frames that are themselves encoded using predictions to reference frames in another video segment. Accordingly, a captured video sequence can be encoded in a way that reduces the number of dependencies to video segments in a geotagged video database.

When compared to the encoding techniques illustrated in FIGS. 7 and 8, the encoding illustrated in FIG. 8 involves utilizing similarities between entire video segments instead of just between intra-frames. When the video segments are captured from similar viewpoints and at similar frame rates, the encoding process is somewhat analogous to conventional multiview encoding. When the video segments are encoded at different frame rates or the video recording devices were in motion at different velocities (particularly relevant to “always on” cameras), then the encoding process becomes more complicated. Instead of each of the frames in the video segments corresponding, the frames in the captured video segment may correspond to a subset of the frames in the reference segment. In addition, only a subset of the frames in the captured video segment may correspond to all or a subset of frames in the reference segment. As is discussed below, these correspondences can still provide significant efficiency gains in the encoding of the captured video segment. When the video segments are encoded at different resolutions, then the encoding process is also more complicated. Relevant frames from a reference segment can be resampled to the resolution of the frames in a captured video segment. These resampled frames can then be used as reference frames in the encoding of the captured video segment. Likewise, during decoding the relevant frames of the reference segment are resampled prior to being used as reference frames in the decoding of the encoded video segment. Ideally, the resampling processes used in the encoding and the decoding are the same or vary within a margin that is appropriate to the requirements of a specific application.

### Improving Encoding Efficiency of Rate of Video

When a video sequence is captured at a high velocity (i.e. the video recording device is in motion) and/or at a low frame rate, significant compression gains can be obtained by using predictions based upon another video segment captured at a slower velocity and/or a higher frame rate. At high velocity or low frame rate, prediction between frames in the captured video sequence may be inaccurate leading to inefficiency in the video encoding process (efficiency is directly tied to the accuracy of predictions). As noted above, the velocity at which a scene is captured and the frame rate at which the scene is captured can have similar impacts on encoding efficiency and can be collectively referred to as the rate of the video. A high rate corresponds to a low velocity and/or high frame rate. A low rate corresponds to a high velocity and/or low frame rate. Where a geotagged video database contains a similar video segment captured at a higher rate (i.e. lower velocity and/or higher frame rate), use of the higher rate video segment as a reference segment can improve the efficiency of the encoding of the captured video sequence by providing reference frames from which better predictions can be made than the predictions that are possible using inter-frame prediction alone.

In a number of embodiments geotags are associated with frames of video that can be utilized to determine velocity and/or that include velocity information (in many instance velocity information derived using frequency shift by a GPS receiver can be more precise than deriving location information from position measurements). In several embodiments, the rate of a video sequence can be considered as a function of both the velocity (as indicated by geotags associated with the sequence and/or frames of the sequence) and the frame rate of the sequence. In a number of embodiments, the rate of a video sequence is determined as the number of frames of video captured over a specified distance (the specific calculation of frames per distance need not be determined, instead a combination of frame velocity and frame rate can be considered in a manner equivalent to frames per distance travelled). The rate of the video sequence can vary from one segment to another based upon variations in velocity of the video recording device that captured the video sequence.

In several embodiments, a geotag including velocity information associated with a frame that is being encoded can be utilized to apply a filter such as (but not limited to) a filter that applies blur simulating motion blur to increase the similarity of a frame in a reference segment. In this way, additional compression gains can be obtained through application of the filter. In several embodiments, the blurring may take place individually on each frame, or alternatively by applying transformations on a combination of two or more frames. In a number of embodiments, a similar effect can be achieved using bi-predictive filtering utilizing the preceding frame in the captured video segment and the reference frame selected from the reference video segment. In other embodiments, any of a variety of filters can be applied to the references of a reference segment to increase similarity to a frame of a captured video segment.

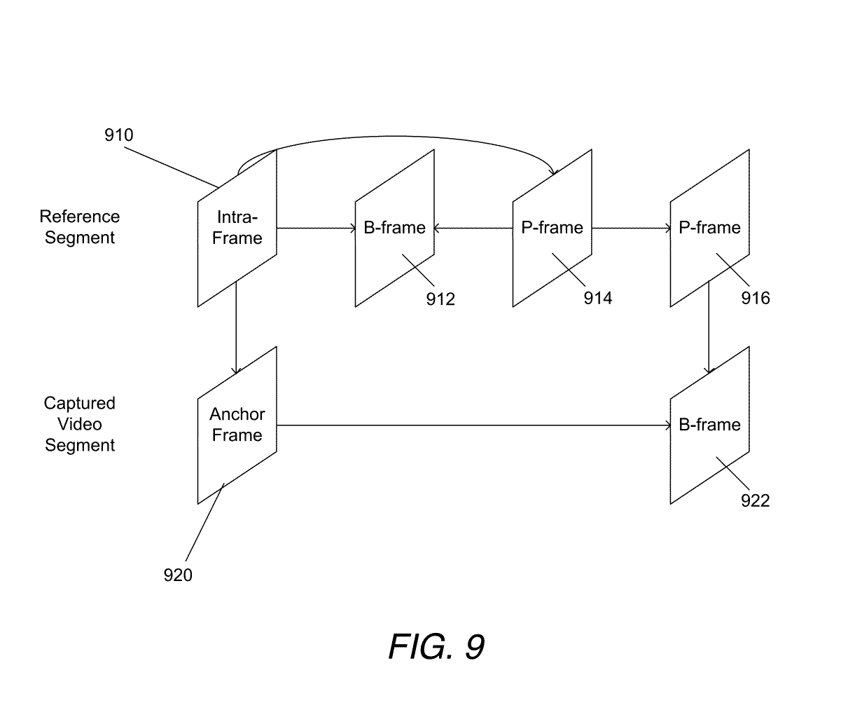

The encoding of a captured video segment using predictions based on a higher rate reference segment located within a geotagged video database in accordance with embodiments of the invention is conceptually illustrated in FIG. 9. A video segment from a geotagged video database constitutes a reference segment. In the illustrated embodiment, the reference segment includes an intra-frame 910 and a plurality of additional frames (912, 914, 916) encoded using intra-frame prediction, and/or inter-frame prediction. A captured video segment is represented by a second sequence of frames. The captured video segment is captured using a video recording device travelling at a higher velocity with respect to the scene than the relative velocity of the video capture device used to capture the reference segment (i.e. at a lower rate to the reference segment). Although FIG. 9 is discussed in the context of the velocity at which the video segments were captured, similar techniques can also be utilized where the reference segment is captured at a higher frame rate than the captured video segment.

The two video segments are not synchronized and so the encoding process identifies the video frame within the reference segment that is most similar to the second frame (922) of the captured video segment. The second frame of the captured video segment can then be encoded at increased efficiency using predictions that include references to the identified frame from the reference segment. As noted above, a filter can be applied to a frame in the reference segment or a plurality of frames in the reference segment based upon velocity information in a geotag associated with the frame being encoded to increase the similarity of the reference frame. In several embodiments, the identification of the most similar frame from the reference segment is performed in a manner similar to that outlined above involving comparison of geotags and/or frame content. In a number of embodiments, the geotag information considered when identifying a similar frame in the reference segment includes velocity information in the geotags associated with each of the video segments. In many embodiments, the geotag information considered when identifying a similar frame includes location information associated with each frame. In this way, a distance baseline can be utilized to align the two video segments (as opposed to a time baseline). The process of comparing the similarity of the content of the frame can involve identifying frame(s) from the reference segment that are more similar than the previous frame in the video segment being encoded.

Although specific processes for encoding video segments using predictions based on reference segments in accordance with embodiments of the invention are discussed above, any of a variety of processes can be utilized to increase the encoding efficiency of a captured video sequence leveraging predictions based upon video segments contained within a geotagged video database in accordance with embodiments of the invention. Furthermore, the above processes with respect to encoding different views captured at different rates (velocity and/or frame rate) can be used generally including in multiview encoding, where the views are captured in a coordinated manner (e.g. fixed baseline, synchronized) at the same time. Processes for storing video encoded in accordance with embodiments of the invention are discussed further below.

### Storing Dependent Streams in a Separate Container File

In several embodiments, each video segment contained within the geotagged video database is contained within a separate container file and the geotagged video database includes an entry with respect to a captured video sequence including metadata concerning the location of the video segments that are combined together to create the captured video sequence and can include an entry concerning the location of reference segments and/or reference frames within the geotagged video database. In several embodiments, the DivX Plus container file format specified by DivX, LLC of San Diego, Calif. is utilized to contain the video segments. In other embodiments, any container file format appropriate to a specific application can be utilized including (but not limited to) the MP4 container file format specified in the MPEG-4 specification and the Matroska Media Container (MKV) specified by the Matroska Non-Profit Organization. In many embodiments, each container file includes a header that includes parameters utilized to configure a decoder to decode the video segment(s) contained within the container file. In several embodiments, the container file includes an index enabling the retrieval of specific frames of video within the video segment.

Referring again to FIG. 7, the storage of a reference segment and a captured video segment in separate video container files in accordance with embodiments of the invention is illustrated. Unlike bitstreams encoded using MVC, where frames from different views are contained within the same access unit, information concerning reference frames from within the reference segment that are utilized in the decoding of the captured video segment is contained within metadata stored in the container file and/or in the geotagged video database. As is discussed further below, a video sharing system can then utilize the metadata identifying video segments and reference frames to retrieve all of the video data utilized in the decoding of the requested video sequence.

Although the embodiment illustrated in FIG. 7 includes a captured video sequence in which only the intra-frames were re-encoded using predictions that reference frames of a reference segment, separate container files can be utilized to store any video segment encoded in accordance with embodiments of the invention. Furthermore, systems and methods in accordance with embodiments of the invention are not limited to storing captured video segments in individual container files. Processes for storing multiple video segments encoded using predictions based on frames in a reference segment that is also contained within a single container file in accordance with an embodiment of the invention are discussed further below.

### Storing Dependent Streams in a Single Container Files

Video segments are dependent when one video segment includes predictions based upon another video segment. In many embodiments, dependent video segments are multiplexed into a single container file so that referenced frames are located prior to the frame that includes the references. In a number of embodiments, the frames of the different video segments are combined into a single bitstream and frames that reference each other are contained within an access unit. Unlike video encoded using MVC, the different video segments are typically not synchronized and are captured at different times. In addition, the video segments may be captured at different frame rates, resolutions, and/or aligned relative to each other based upon a distance baseline instead of a time baseline. Storing dependent video segments in a single container file can simplify the process of decoding one of the video segments, because all of the video data utilized to decode the video segment is stored with the video segment. Where an encoded segment includes dependencies to multiple reference segments, the frames of each segment are multiplexed together so that the frames from the various segments are ordered so that each frame that is utilized as a reference frame is located prior to the frames that reference it in the container file. In addition, information concerning the dependencies between frames is included within the container file. Unlike MVC, where access units define frames that can be reference frames between views, the reference frames are specifically identified within the container file.

Referring again to FIG. 8, a pair of video segments stored within a single container file 830 is shown. The video segments are captured at the same frame rate and so a frame from each video segment is contained within each access unit. In several embodiments, the video segments are captured at different frame rates, different resolutions, and/or with the video recording devices travelling at different velocities relative to the scene. Accordingly, some access units may contain a single frame of video. In a number of embodiments, dependent frames are not stored in the same access unit. Instead, the frames are multiplexed into a container file so that related frames are grouped within the container. The video segments are, however, encoded as separate bitstreams.

Although specific techniques for storing video segments encoded in accordance with embodiments of the invention are disclosed above with respect to FIGS. 7 and 8, any of a variety of techniques can be utilized to store video segments within a geotagged video database in accordance with embodiments of the invention. Processes for distributing video sequences stored within a geotagged video database in accordance with embodiments of the invention are discussed further below.

### Distribution of Content

Video sharing systems in accordance with embodiments of the invention can receive requests to access video sequences stored within the geotagged video database. The manner in which the video sequences are accessed can depend upon the capabilities of a playback device and/or the requirements of a specific application. In many embodiments, the video sharing system streams requested video sequences to playback devices for decoding. In several embodiments, playback devices download video sequences from the video sharing system and (progressively) playback the downloaded video sequences. In many instances, the requested video sequence will be a conventional bitstream and the playback device can playback the video sequence directly. Where the video sharing system has divided the video sequence into video segments, the playback device may need to request and assemble the video segments in an appropriate order. Typically, information concerning the assembly of video segments to reconstruct a requested video sequence can be obtained from the video sharing system using a mechanism such as (but not limited to) a top level index file including the locations of each of the video segments and the playback order of the video segments. In several embodiments, the top level index file is generated when the video sequence is stored in the geotagged video database. In other embodiments, the top level index file is dynamically generated in a manner similar that described in U.S. patent application Ser. No. 13/341,801, filed Dec. 30, 2011 and entitled “Systems and Methods for Performing Adaptive Bitrate Streaming Using Automatically Generated Top Level Index Files”, the disclosure of which is incorporated by reference herein in its entirety.

In a number of instances, a requested video sequence will include one or more video segments encoded using predictions that include references to a reference segment. In several embodiments the video sharing system provides the requested video sequence, and the reference segments upon which segments of the requested video sequence depend and the playback device decodes the requested video sequence using the reference segments. In a number of embodiments, the video sharing system multiplexes the requested video sequence and the reference segments into a container file in response to the request and the container file is provided to the playback device. In certain embodiments, the container files are cached to reduce server load with respect to frequently requested video sequences. In many embodiments, the video sharing system transcodes the segments of the requested video sequence that include predictions to reference segments to provide the playback device with a conventional video bitstream. Processes for transcoding and decoding video encoded in accordance with embodiments of the invention are discussed further below.

### Distributing Encoded Content

When a playback device that includes a video decoding system requests a video sequence that includes segments encoded using predictions that reference frames of reference segments, a video sharing system in accordance with embodiments of the invention can provide the requested video segments and all of the frames referenced in the encoding of the requested video segments. In this way, the playback device is provided with all of the video data to decode and playback the video sequence.

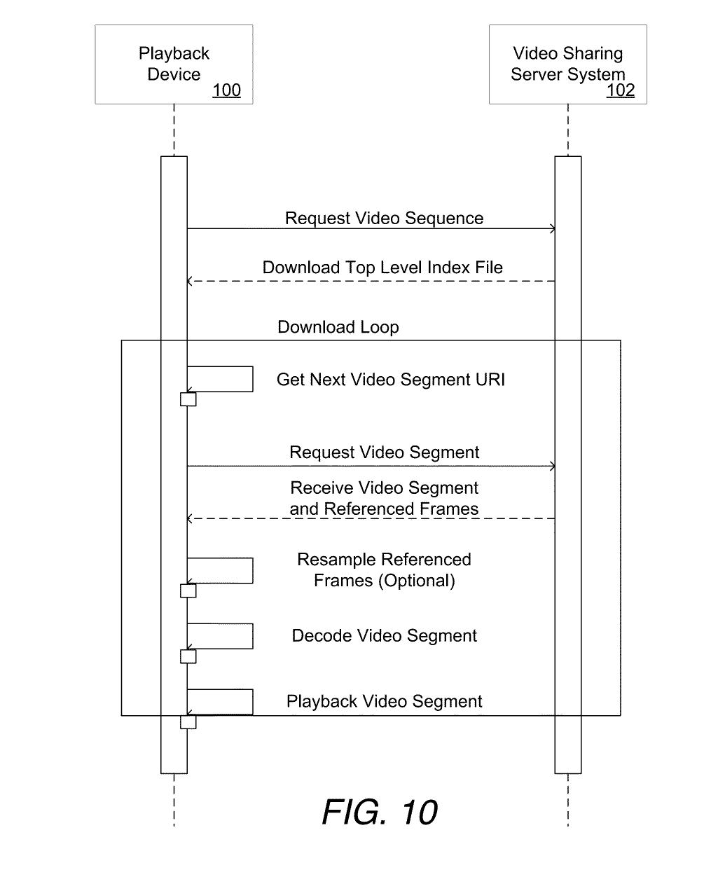

A timing diagram illustrating communication between a playback device and a video sharing server system during the decoding and playback of a video segment encoded using predictions that reference frames in reference segments in accordance with an embodiment of the invention is illustrated in FIG. 10. A playback device 100 initiates the download by requesting a video sequence from a video sharing server system 102. In response to the request, the video sharing server system is provided with access to a top level index file containing the location(s) of one or more video segments that combine to form the requested sequence. In the illustrated embodiment, the location(s) of the one or more video segments are indicated using URIs. The top level index file can be stored on the video sharing server system or dynamically generated based upon metadata stored in a geotagged video database concerning the location of encoded video segments and reference frames. In other embodiments, any of a variety of techniques can be utilized to provide a playback device with information concerning the location of the video segments that make up a requested video sequence.

Using the top level index file, the playback device 100 enters a download loop in which the playback device selects one or more URIs associated with the next video segment to be played back in the video sequence and requests the video segment using the one or more URIs. In many embodiments, the one or more URIs enable the playback device to directly download the video segment and any frames referenced in the encoding of the video segment. In several embodiments, the video sharing server system receives the URI and queries a geotagged video database to locate metadata identifying the video segment and frames referenced in the encoding of the segment. The video sharing server system can then provide the identified information to the playback device for decoding. The playback device places frames in the video decoder's reference frame list and decodes the video segment using any referenced frames downloaded from the video sharing server system. Where the reference frames are encoded at a different resolution to the resolution of the video segment, the playback device can resample the frames to the resolution of the video segment prior to placing them in the decoder's reference list. The method used to perform the resampling during encoding and decoding may be the same, or similar within an acceptable error tolerance; otherwise, a mismatch in the resampling may lead to drift between the encoder and decoder's prediction processes. Factors that can influence the similarity of resampling processes include (but are not limited to) the filter length, filter taps, number of vertical lines, and/or boundary conditions applied during the resampling process. The resampling method may be predetermined, communicated via external means to the video file, or added as metadata concerning the encoded video segment to a container file or within the encoded video bitstream. The decoded video segment is then played back. The playback device can request the next video segment until all of the video segments in a video sequence are played back. As is illustrated in FIG. 2A, some of the video segments in a requested video sequence may not reference frames from a reference segment and can be decoded and played back in a conventional manner.

In embodiments where video segments are stored on a geotagged video database in separate container files, the top level index file can include references to the container file of the video segment and to the byte ranges of frames of video within another container file that are referenced in the encoding of the video segment. The playback device can then download the container file containing the video segment, the headers of the container file containing the referenced frames, and the referenced frames. Where dependent video segments are stored in the same container file within a geotagged video database, the playback device 100 can download the headers and index of the container file and use the index to identify the byte ranges of the container file to download to obtain the video segment and the frames referenced in the encoding of the video segment. A playback application on the playback device can handle providing the appropriate reference frames to a video decoder to enable decoding of the video segment. Alternatively, the playback device 100 can download the entire container file.

Although a specific process for downloading video segments and frames referenced in the encoding of the video segments is illustrated in FIG. 10, any of a variety of processes including multiplexing the requested video sequence and the reference segments into a container file on the fly can be utilized to enable downloading and playback video encoded in accordance with embodiments of the invention. Processes involving transcoding video segments encoded in accordance with embodiments of the invention to provide conventional bitstreams to playback devices are discussed further below.

### Transcoding Content Prior to Distribution

As an alternative to providing playback devices with both video segments and any frames referenced in the encoding of the video segments, the bandwidth utilized during the downloading of a video segment can be reduced by transcoding a video segment into a conventional bitstream. A playback device receiving the transcoded bitstream can simply decode the transcoded bitstream using a conventional decoder.

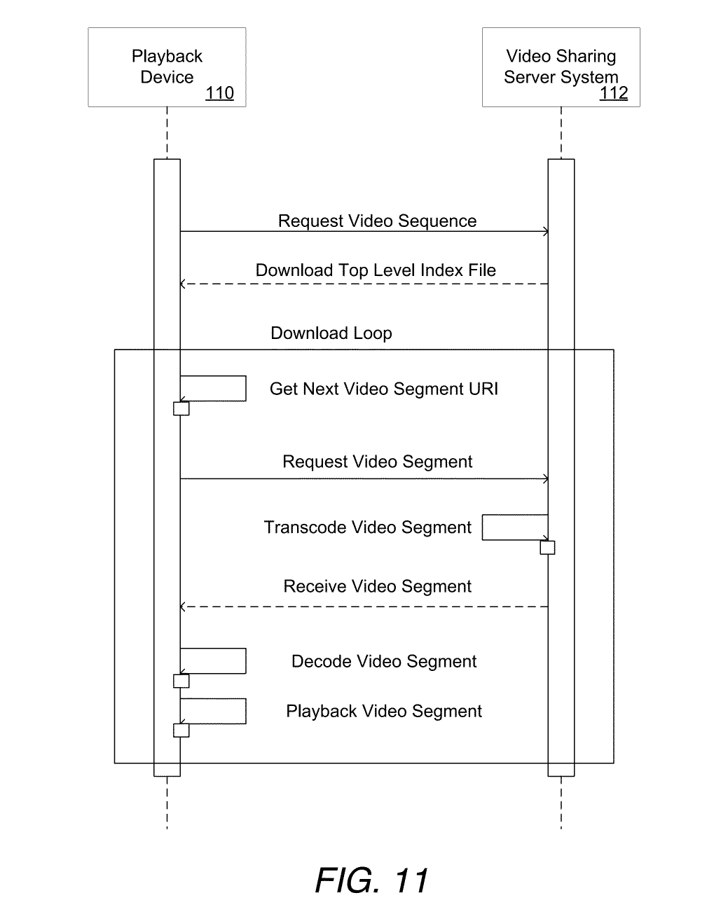

A timing diagram illustrating communication between a playback device and a video sharing server system during the decoding and playback of a video segment encoded using predictions that include references to frames in reference segments in accordance with an embodiment of the invention is illustrated in FIG. 11. A playback device 110 initiates the download by requesting a video sequence from a video sharing server system 112. The video sharing server system 112 responds to a request to download a video segment encoded using predictions that include references to a reference segment by transcoding the requested video segment into a conventional bitstream prior to providing the video segment to the playback device. Where the reference segment is a different resolution to the video segment, then referenced frames in the reference segment are resampled to the resolution of the video segment prior to decoding. As noted above, ideally the same resampling process as used during encoding or a resampling process that yields an acceptable amount of error is utilized during the decoding process. The specific resampling process can be predetermined or determined based upon metadata describing the encoded video segment. The playback device 110 can then simply decode and playback the transcoded bitstream in a conventional manner.

Although specific processes for obtaining and playing back video sequences encoded in accordance with embodiments of the invention are illustrated in FIGS. 10 and 11, any of a variety of processes can be utilized to decode and playback video contained within a geotagged video database in accordance with embodiments of the invention.

### Reducing Complexity of Decoding Processes

Multiview encoding processes typically support encoding a video segment using reference frames that can themselves be encoded using predictions that reference other video segments. Accordingly, the complexity of decoding a video segment typically depends upon the number of dependencies (i.e. the number of frames that are decoded during the process of decoding a specific frame). In several embodiments, the complexity of the decoding process is reduced by limiting the number of dependencies allowed when encoding a captured video segment. Accordingly, video sharing systems in accordance with a number of embodiments of the invention employ a cost function when determining the similarity in the match between frames and/or video segments that prefers video segments encoded without dependencies to other video segments. Similar cost functions can weight the desirability of a match inversely with the number of dependencies.

In many embodiments, a video sharing system can actively manage the dependencies within a geotagged video database to transcode video sequences that include predictions to reference segments and vice versa. In this way, the video sharing system can identify a video segment that is a good match for a captured video sequence and determine whether the sequence can be transcoded to become a reference segment that does not depend on other video segments. In the event that the reference segment on which the matching video segment depends does not include any (or many) dependencies, then the video segments can be transcoded so that the dependencies are reversed. In the event that a reference segment has many dependencies, the video sharing system can determine whether the reference segment is a suitable match (although not the best match) for encoding the captured video segment. In the event that the captured video segment is similar to several video segments that depend to the same reference segment, a determination can be made concerning whether greater encoding efficiency could be obtained over the set of video segments by shifting the encoding dependencies to another of the video segments (e.g. the captured video segment or the closest matching video segment). In this way, the video sharing system can actively manage the geotagged video database to continuously reduce the number of dependencies in the encoding of the video segments and to improve the overall compression of the database.

### Playback Devices

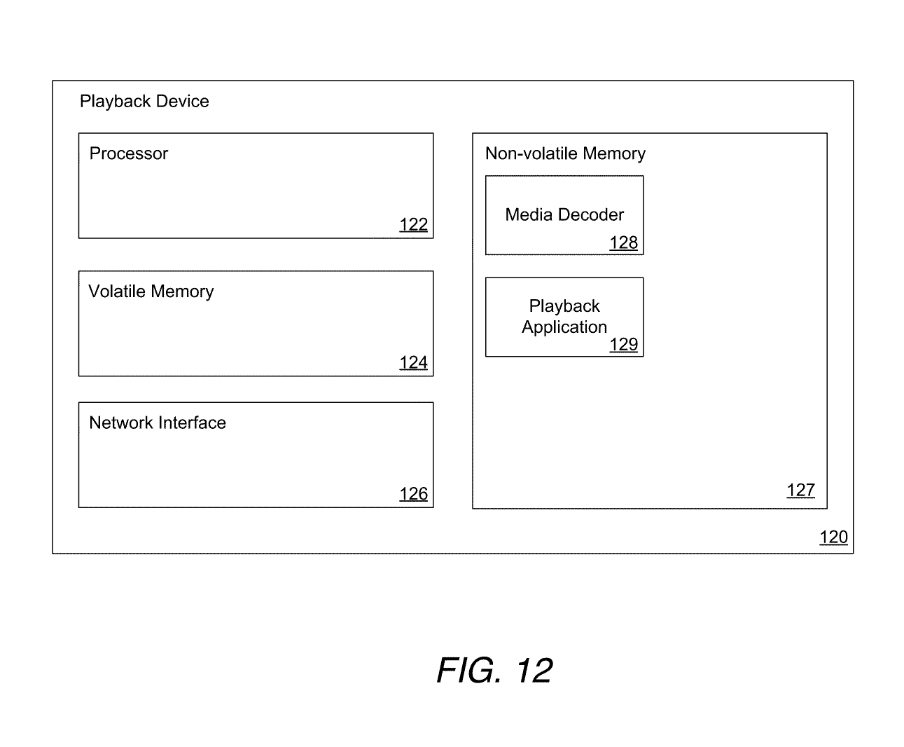

Playback devices in accordance with many embodiments of the invention are tasked with decoding video segments encoded using predictions based upon reference frames in unsynchronized video segments. A playback device including a video decoding system in accordance with an embodiment of the invention is illustrated in FIG. 12. The playback device 120 includes a processor 122, volatile memory 124, a network interface 126 and non-volatile memory 127. In the illustrated embodiment, the non-volatile memory includes a media decoder 128 and a playback application 129. In many embodiments, the playback application is configured to obtain encoded video segments and reference frames and to provide the encoded video segments and the reference frames to a media decoder in a way that enables the decoding of the video segments.

In several embodiments, the playback application 129 obtains a top level index file from a video sharing server system via the network interface 126. The top level index file provides information concerning files containing video segments and reference frames utilized in the decoding of the video segments. In a number of embodiments, the playback application 129 can utilize HTTP or a similar stateless (or stateful) protocol to request encoded video segments and reference frames via the network interface 126 in accordance with the information contained within the top level index file. In several embodiments, the playback application 129 obtains a first header including parameters for decoding a video segment and a second header including parameters for decoding reference frames in a second video segment. Where the encoding of the two video segments is sufficiently different (e.g. different resolutions), the playback application instantiates two media decoders 128 and configures the first media decoder with the first set of decoding parameters and configures the second media decoder with the second set of decoding parameters. The frames decoded by the second media decoder can then be provided to the reference frame list of the first media decoder for use in the decoding of the video segment using the first media decoder. Where there are differences in resolution, the playback application can resample the frames decoded by the second media decoder to the resolution of the first video segment prior to providing the reference frames to the first media decoder. As noted above, ideally the same resampling process as used during encoding or a resampling process that yields an acceptable amount of error is utilized during the decoding process. The specific resampling process can be predetermined or determined based upon metadata describing the encoded video segment. The metadata can be obtained separately from the encoded video segment and/or be embedded within the encoded video segment. In a number of embodiments, the decoders share a reference frame list. In yet other embodiments, a single decoder is instantiated and the video frames are decoded in bitstream order and according to the order of access units in the file, such that the reference frames from the reference segments can be utilized during decoding.

In a number of embodiments, a requested video segment and associated reference frames are contained in separate container files and the top level index file is used to obtain an index to the container file(s) containing the reference frames. The index(es) can then be used by the media decoder to obtain the reference frames from within each of the reference files.

Although specific playback devices are described above with respect to FIG. 12, any of a variety of playback devices can be utilized in accordance with embodiments of the invention including (but not limited to) playback devices in which the playback application 129 is downloaded and stored in volatile memory, and/or is stored elsewhere. In addition, playback devices in accordance with embodiments of the invention can implement a conventional media decoder and the complexity associated with the retrieval and decoding of the reference frames can be handles at the server, with the playback device receiving a conventional bitstream that can readily be decoded. Server systems that transcode video segments prior to providing requested video segments to playback devices in accordance with embodiments of the invention are discussed below.

### Video Sharing Server Systems

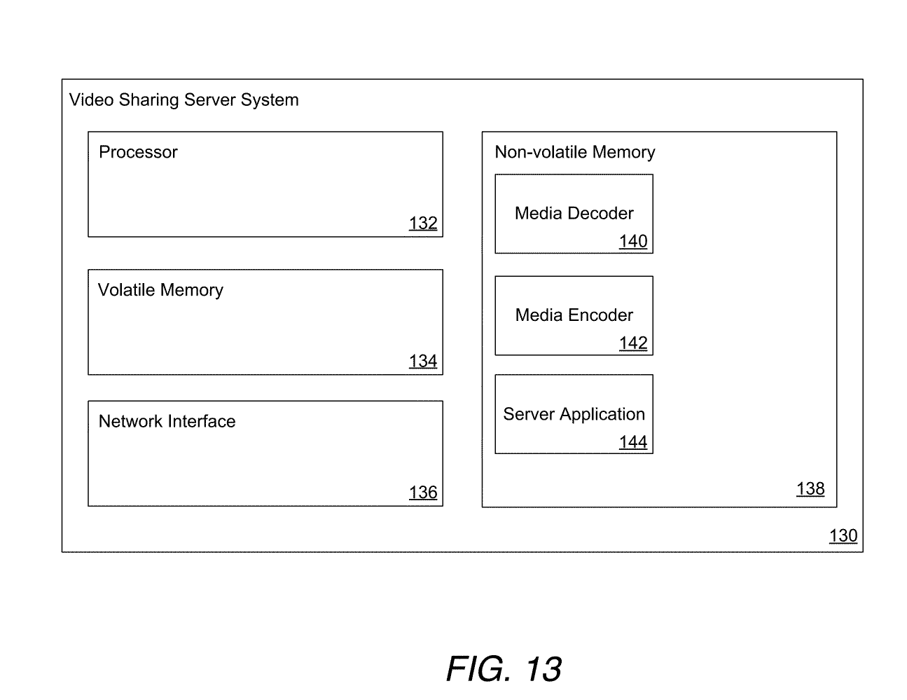

Video sharing server systems in accordance with many embodiments of the invention can retrieve video segments and reference frames from a geotagged video database and transcode the video segments on the file into a conventional bitstream that can be readily decoded and played back by a conventional video decoder. A video sharing server system in accordance with an embodiment of the invention is illustrated in FIG. 13. The video sharing server system 130 includes a processor 132, volatile memory 134, a network interface 136, and non-volatile memory including a media decoder 140, a media encoder 142 and a server application 144. When the video sharing server application receives a captured video sequence, the server application 144 configures the processor to utilize the media encoder 142 to encode the video in the manner outlined above utilizing predictions that include references to frames in geotagged video segments (where possible) to achieve increased compression.

In a number of embodiments, the server application 144 responds to a request to access a stored video sequence by transcoding video segments that are part of the video sequence and which are encoded using predictions based upon reference frames contained within other video segments. The server application 144 transcodes the video segment by decoding the video segment in the manner similar to the decoding processes described above with respect to the playback device 120 illustrated in FIG. 12. Where the reference segment and the video segment being decoded have different resolutions, the reference frames from the reference segment are resampled to the resolution of the video segment prior to use in decoding. As noted above, ideally the same resampling process as used during encoding or a resampling process that yields an acceptable amount of error is utilized during the decoding process. The specific resampling process can be predetermined or determined based upon metadata describing the encoded video segment. The metadata can be located within the file containing the encoded video segment, within the encoded bitstream of the encoded video segment, and/or maintained in another location including (but not limited to) within the geotagged video database. The server application 144 then causes the decoded video segment to be reencoded as a conventional bitstream using the media encoder 142. The server application 144 can stream the transcoded video to a playback device using a stateful protocol. Alternatively, the server application 144 can complete the transcoding and generate a top level index file that can be utilized by a playback device to request the transcoded bitstream. In a number of embodiments, the server application 144 caches transcoded video segments. In circumstances where a transcoded video segment is repeatedly requested, the server application 144 can replace the encoding of the video segment in the database with the transcoded video segment to reduce the load on the server. In addition, the server application 144 can determine whether the transcoding of the video segment creates opportunities to otherwise the compress the video segments in the geotagged video database by transcoding the video segments on which the transcoded video segment previously depended to take advantage of the transcoded bitstream, which may be a better match (or a lower dependency match).

Although specific video sharing server systems are described above with respect to FIG. 13, any of a variety of video sharing server systems can be utilized in video sharing systems in accordance with embodiments of the invention including (but not limited to) video sharing server systems that simply handle generation of top level index files that point to the location of container files containing video segments on HTTP servers and/or within Content Distribution Networks. In addition, the processes described above as being performed by a video sharing server system should be understood as potentially being performed by several servers. Furthermore, the server application described above with respect to FIG. 13 should be appreciated as capable of being implemented as several separate applications and/or on different servers.

While the above description contains many specific embodiments of the invention, these should not be construed as limitations on the scope of the invention, but rather as an example of one embodiment thereof. For example, the use of the terms captured video sequence and captured video segment should be understood as being illustrative only and not limiting to encoding processes applied at the time of ingest into a geotagged video database. Encoding processes in accordance with embodiments of the invention can be applied to video segments previously stored within a geotagged video database and to reencode segments previously encoded in accordance with embodiments of the invention. Accordingly, the scope of the invention should be determined not by the embodiments illustrated, but by the appended claims and their equivalents.

What is claimed:

1. A method of decoding a first video sequence that captures a view of a scene and is encoded using predictions that include references to a second video sequence that captures a similar view of the scene at a higher rate, where information is associated with frames of the first video sequence that identifies reference frames in the second video sequence, the method comprising:
decoding at least a plurality of the frames in the first video sequence by:
identifying information associated with the frame in the first video sequence that identifies a reference frame in the second video sequence using the video decoding system;
decoding the reference frame from the second video sequence identified by the information in the first video sequence using the video decoding system;
decoding the frame in the first video sequence using predictions based on the decoded reference frame using the video decoding system; and
skipping frames in the second video sequence that are not identified as reference frames by the information associated with the frames in the first video sequence.

2. The method of claim 1, wherein:
both the first and second video sequences capture similar views of the scene in which the recording devices that captured the views of the scene were moving relative to the scene; and
the second video sequence captures the scene at a higher rate, because the video recording device that captured it was travelling at a lower velocity relative to the scene than the video recording device that captured the first video sequence.

3. The method of claim 1, wherein the second video sequence captures a similar view of the scene at a higher rate than the first video sequence, because the second video sequence has a higher frame rate.

4. The method of claim 1, wherein a plurality of the frames of the first video sequence do not reference any frames in the second video sequence.

5. The method of claim 1, wherein the first and second video sequences are encoded using different encoding parameters.

6. The method of claim 1, wherein the first and second video sequences were captured using different video recording devices.

7. The method of claim 1, wherein:
the resolutions of the first and second video sequences are different;
decoding a reference frame from the second video sequence comprises:
decoding a frame from the second video sequence; and
resampling the decoded frame to the resolution of the encoded video sequence to generate the reference frame.

8. The method of claim 7, wherein the resampling process used by the video decoding system is predetermined.

9. The method of claim 7, wherein:
the first video sequence is encoded as an elementary bitstream that includes metadata indicating a resampling process to apply to the frames of the second video sequence;
resampling the decoded frame to the resolution of the first video sequence to generate the reference frame further comprises:
extracting the metadata indicating the resampling process to apply to the frames of the second video sequence from the elementary bitstream of the first video sequence using the video decoding system; and
resampling the decoded frame to the resolution of the first video sequence using the indicated resampling process to generate the reference frame.

10. The method of claim 7, wherein:
the first video sequence is stored in a container file that includes metadata indicating a resampling process to apply to the frames of the second video sequence;
resampling the decoded frame to the resolution of the first video sequence to generate the reference frame further comprises:
extracting the metadata indicating the resampling process to apply to the frames of the second video sequence from the container file containing the first video sequence using the video decoding system; and
resampling the decoded frame to the resolution of the first video sequence using the indicated resampling process to generate the reference frame.

11. The method of claim 7, wherein:
metadata indicating the resampling process to apply to the frames of the second video sequence is stored in a database; and
resampling the decoded frame to the resolution of the first video sequence to generate the reference frame further comprises:
extracting the metadata indicating the resampling process to apply to the frames of the second video sequence from the database using the video decoding system; and
resampling the decoded frame to the resolution of the first video sequence using the indicated resampling process to generate the reference frame.

12. The method of claim 1, wherein:
the first video sequence is stored in a first container file;
the second video sequence is stored in a second container file; and
the method further comprises:
obtaining video data including frames of the first video sequence from the first container file using the video decoding system; and
obtaining video data including a frame of the second video sequence from the second container file in response to identifying information associated with a frame in the first video sequence that identifies the frame from the second sequence as a reference frame using the video decoding system.

13. The method of claim 12, further comprising:
obtaining a top level index file that includes the location of the first and second container files using the video decoding system; and
using the top level index file to obtain video data from the first and second container files using the video decoding system.

14. The method of claim 1, wherein:
the first and second video sequences are multiplexed into a single container file; and
the method further comprises:
obtaining video data including frames of the first video sequence from the container file using the video decoding system; and
obtaining video data including a frame of the second video sequence from the container file in response to identifying information associated with a frame in the first video sequence that identifies the frame from the second sequence as a reference frame using the video decoding system.

15. The method of claim 1, further comprising:
configuring a first video decoder within the video decoding system to decode the second video sequence; and
configuring a second video decoder within the video decoding system to decode frames from the first video sequence using at least one frame from the second video sequence decoded by the first video decoder.

16. The method of claim 1, wherein:
a geotag is associated with at least one of the frames of the first video sequence; and
the method further comprises:
determining a velocity associated with the frame in the first sequence that is being decoded by the video decoding system using at least the geotag; and
applying a filter to the reference frame from the second video sequence identified by the information associated with the first video sequence using the video decoding system, where the filter is selected based upon the velocity associated with the frame in the first sequence.

17. A playback device, comprising:
a processor; and
memory containing a playback application;
wherein the playback application configures the processor to:
store at least a portion of a first video sequence that captures a view of a scene and is encoded using predictions that include references to a second video sequence that captures a similar view of the scene at a higher rate in memory;
store at least a portion of the second video sequence in memory; and
wherein the playback application decodes at least a plurality of the frames in the first video sequence by configuring the processor to:
identify information associated with the frame in the first video sequence that identifies a reference frame in the second video sequence;
decode the reference frame from the second video sequence;
decode the frame in the first video sequence using predictions based on the decoded reference frame; and
skip frames in the second video sequence that are not identified as reference frames by the information associated with the frames in the first video sequence.

18. The playback device of claim 17, wherein:
both the first and second video sequences capture similar views of the scene in which the recording devices that captured the views of the scene were moving relative to the scene; and
the second video sequence captures the scene at a higher rate, because the video recording device that captured it was travelling at a lower velocity relative to the scene than the video recording device that captured the first video sequence.

19. The playback device of claim 17, wherein the second video sequence captures a similar view of the scene at a higher rate than the first video sequence, because the second video sequence has a higher frame rate.

20. A machine readable medium containing processor instructions, where execution of the instructions by a processor causes the processor to perform a process that comprises:
storing at least a portion of a first video sequence that captures a view of a scene and is encoded using predictions that include references to a second video sequence that captures a similar view of the scene at a higher rate in memory;
storing at least a portion of the second video sequence in memory; and
decoding at least a plurality of the frames in the first video sequence by:
identifying information associated with the frame in the first video sequence that identifies a reference frame in the second video sequence;
decoding the reference frame from the second video sequence;
decoding the frame in the first video sequence using predictions based on the decoded reference frame; and
skipping frames in the second video sequence that are not identified as reference frames by the information associated with the frames in the first video sequence.
